(19) United States
(12) Patent Application Publication
(10) Pub. No.: US 2024/0013582 A1
(43) Pub. Date: Jan. 11, 2024

(54) DIGITAL TWIN BASED VEHICLE EVALUATION ENGINE

(71) Applicant: Bank of America Corporation, Charlotte, NC (US)

(72) Inventors: Maharaj Mukherjee, Poughkeepsie, NY (US); Carl M. Benda, Charlotte, NC (US)

(21) Appl. No.: 17/857,407

(22) Filed: Jul. 5, 2022

(51) Int. Cl. G07C 5/00; G07C 5/08

(52) U.S. Cl. CPC G07C 5/008; G07C 5/0816; G07C 5/0841; G07C 5/006

(57) ABSTRACT

Aspects of the disclosure relate to digital twin simulation. A computing platform may train, using historical vehicle information, a digital twin vehicle evaluation engine, configured to model a vehicle based on characteristics of the vehicle using a computer simulation. The computing platform may receive, from a client device, an event processing request identifying a first vehicle. The computing platform may generate, using the digital twin vehicle evaluation engine, a computer simulation of the first vehicle. The computing platform may execute, over a simulated period of time, the computer simulation of the first vehicle to output event processing information for the first vehicle. The computing platform may send, to the client device, the event processing information and one or more commands directing the client device to display the event processing information, which may cause the client device to display the event processing information.

### BACKGROUND

Aspects of the disclosure relate to digital twin modeling. In some cases, models, such as machine learning models, may be used for prediction. Due to limited computing resources, processing power, and/or machine learning model capabilities, the number of features considered by such models may be limited. For example, engineers, administrators, and/or other individuals may perform feature engineering to identify a subset of features related to a use case that may have the greatest impact on the model's output. In such instances, however, remaining features may be disregarded. This may result in identification of an output that might not be as accurate as a hypothetical output in which all features were considered by the model. Accordingly, it may be advantageous to train, generate, and/or otherwise host a model capable of analyzing all related features of a use case (e.g., without limiting the number of features through feature engineering), while balancing the limitations of computing resources such as available memory, processing power, and/or other resources.

### SUMMARY

Aspects of the disclosure provide effective, efficient, scalable, and convenient technical solutions that address and overcome the technical problems associated with modeling vehicles and forecasting value. In accordance with one or more embodiments of the disclosure, a computing platform comprising at least one processor, a communication interface, and memory storing computer-readable instructions may receive historical vehicle information. The computing platform may train, using the historical vehicle information, a digital twin vehicle evaluation engine, configured to model a vehicle based on characteristics of the vehicle using a computer simulation, where: 1) training the digital twin vehicle evaluation engine may configure the digital twin vehicle evaluation engine to output event processing information for the vehicle, and 2) training the digital twin vehicle evaluation engine may include generating a knowledge graph, where each node of the knowledge graph may be a machine learning model and each edge of the knowledge graph may represent relationships between features corresponding to each machine learning model. The computing platform may receive, from a client device, an event processing request identifying a first vehicle. The computing platform may generate, using the digital twin vehicle evaluation engine, a computer simulation of a lease term corresponding to the first vehicle. The computing platform may execute, for a period of time corresponding to the lease term, the computer simulation of the first vehicle to output event processing information for the first vehicle. The computing platform may send, to the client device, the event processing information and one or more commands directing the client device to display the event processing information, which may cause the client device to display the event processing information.

In one or more instances, the historical vehicle information may include, for a plurality of vehicles including the first vehicle, one or more of: maintenance cost information, fuel consumption information, insurance cost information, occupancy information, pricing information, vehicle component information, safety information, and/or other information. In one or more instances, the machine learning models may be one or more of: a vehicle market trend model, a weather model, a vehicle maintenance model, a fuel consumption model, an occupancy model, a vehicle safety model, specific vehicle component models, a stock market model, and/or other models.

In one or more examples, the machine learning models may be characterized by different time scales. In one or more examples, the machine learning models may output information for each of a plurality of features, and feature engineering may be used to provide a model output by a single machine learning model, which may cause at least one of the plurality of features to not be analyzed by the single machine learning model.

In one or more instances, the relationships between the features may indicate how each feature affects other features. In one or more instances, the relationships may be manually defined. In one or more instances, the event processing information may indicate one or more of: loan information or a risk score indicating a level of risk associated with providing a loan for one of: a purchase or a lease of the first vehicle.

In one or more examples, the event processing information may include an explanation of the loan information or the risk score. In one or more examples, the event processing information may indicate a second vehicle, with a predetermined number of matching features to the first vehicle, along with loan information for both the first vehicle and the second vehicle, where the second vehicle has a lower risk score than the first vehicle, and a lower interest rate than the first vehicle.

In one or more instances, the computing platform may configure an application programming interface (API) to access one or more additional digital twin vehicle evaluation engines, each hosted by a third party system corresponding to one of: a vehicle manufacturer, a vehicle dealer, a vehicle component manufacturer, or other third party, which may enable the computing platform to access outputs from the one or more additional digital twin vehicle evaluation engines, and outputting the event processing information for the first vehicle may be further based on the outputs.

In one or more embodiments, the one or more additional digital twin vehicle evaluation engines may be trained using additional information, not included in the historical vehicle information. In one or more embodiments, the first vehicle may be one of: a personal vehicle, a recreational vehicle, a motorcycle, a boat, or other vehicle.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for digital twin modeling of vehicles in accordance with one or more example embodiments;

FIGS. 2A-2C depict an illustrative event sequence for digital twin modeling of vehicles in accordance with one or more example embodiments;

FIG. 3 depicts an illustrative method for digital twin modeling of vehicles in accordance with one or more example embodiments; and

FIGS. 4 and 5 depict illustrative graphical user interfaces for digital twin modeling of vehicles in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances, other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction to the concepts described further herein, one or more aspects of the disclosure describe a digital twin-based vehicle evaluation engine to help customers make loan decisions. Buying or leasing a vehicle may be one of the most important financial decisions a bank customer may make in their lifetime. The decision may involve uncertainties on both the lender and borrower sides, as many events may occur during the duration of a loan or lease (which may, e.g., be a number of years).

Buying or leasing a vehicle may be expensive, and may involve repaying a loan consisting of principle and interest, as well as paying maintenance costs, lease payments, fuel costs, and/or other costs.

A lender may usually make loan assumptions based on the current situations and circumstances, which may lead to a conservative decision, denying loans to people who may be qualified, and thus losing the potential income from such loans. Sometimes, the lender may, in spite of their cautions, misjudge the paying capacity of the borrowers. Although the borrower may have the income sufficient to make loan payments themselves, the cost of maintaining a vehicle may involve additional costs (e.g., repair costs, maintenance costs, fuel costs, and the like). The higher such additional costs become, the greater the chance of a user being unable to repay a loan. The borrower, on the other hand, may be optimistic about their ability to repay the loan (and might not, in some circumstances, consider such additional costs).

Accordingly, it may be advantageous to develop a tool that may help users make a reasonable estimate of the costs of vehicle ownership/leases to help facilitate loan decisions. A digital twin of a vehicle model may help both the lender as well as the borrower to make a reasonable estimate of the costs of ownership of a vehicle to facilitate loan decisions.

A digital twin model may be designed to accurately reflect a physical object. The object being studied (e.g., a vehicle or other item) may be outfitted with various sensors related to vital areas of functionality. These sensors may produce data about different aspects of the vehicle's performance, such as fuel consumption, mileage, battery life, engine functionality, and/or other aspects. This data may then be related to a processing system and applied to the digital copy.

Once informed with such data, the virtual model may be used to run simulations, study performance issues, generate possible improvements, and/or perform other actions, all with the goal of generating valuable insights, which may then be applied back to the original physical object.

Although simulations and digital twins both utilize digital models to replicate a system's various processes, a digital twin may actually be a virtual environment, which may make it considerably richer for study. The difference between digital twin and simulation may be a matter of scale. For example, while a simulation may study a single process, a digital twin may itself run any number of useful simulations in order to study multiple processes.

Furthermore, simulations might not benefit from having real-time data. Digital twins, however, may be designed around a two-way flow of information that may first occur when object sensors provide relevant data to the system processor, and then insights created by the processor may be shared back with the original source object.

The system described herein may support a plug and play digital twin of a vehicle that may simulate costs of maintenance, fueling, and/or other repair and outcome-based simulations, predictions and/or estimates to help make loan decisions at different times and/or for different loan durations.

The digital twin of the vehicle may be a plug and play model that may be extended for vehicle features such as make, model, year, size, number of doors, engine type, battery type, fuel capacity, and/or other information. In some instances, the digital twin may also consider other external factors that may affect vehicle prices such as weather, location, market trends, and/or other information.

In some instances, the model may accept internet of things sensor data if available from a vehicle. If the data is not available, it may be extrapolated and/or otherwise customized for any type of vehicle. In the latter case, it may use publicly available data to build an intelligent prediction model. In some instances, the user may be able to provide a specification for a vehicle that may be digitally read and used to make a prediction.

The specification may be generated during design or manufacture of the vehicle, or may be available from a public record of previous vehicle sales/leases. If such information is not available, information from similar vehicles may be used to make a prediction.

The user may then provide the duration for which the simulation is needed. It may, for example, make cost estimates over the term of a lease.

Accordingly, described herein is a data and knowledge driven digital twin-based simulation engine to help customers and lenders make lending decisions based on a customizable simulation of vehicles based on different scenarios. The system may improve valuation of debt to income and/or risk estimation for significant expenditures based on lifespan of various aspects of the vehicles. The exact vehicle information for each vehicle might not be needed. Rather, a digital twin may be created to simulate all types of vehicles. This plug and play digital twin simulation model may be used for vehicle appraisal and loan configuration/formulation. The model may be extended for vehicles of varying characteristics. The model may be used to calculate maintenance costs (e.g., replacing tires, brakes, batteries, and/or otherwise repairing the vehicle, and/or other costs), and may identify whether the applicant is able to afford the cost of the loan in addition to the maintenance or other ancillary costs.

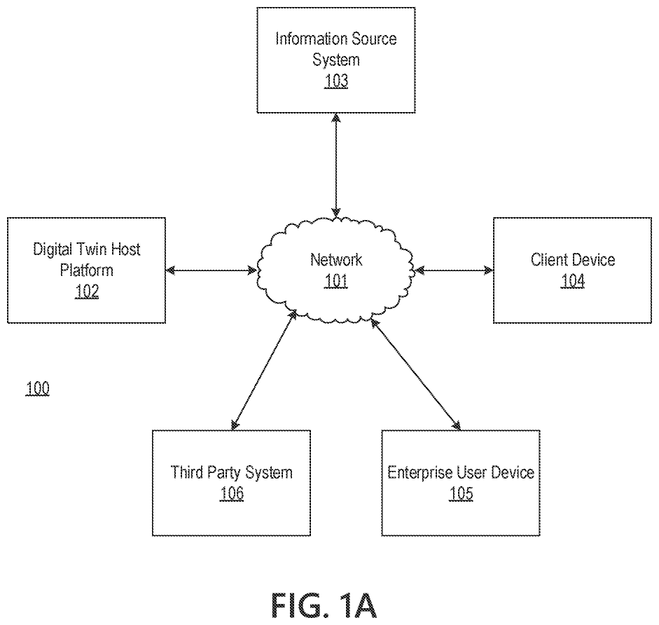

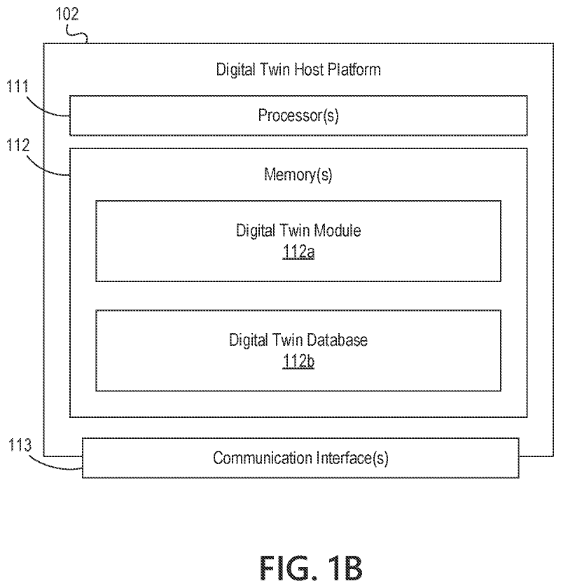

FIGS. 1A-1B depict an illustrative computing environment for digital twin modeling of vehicles in accordance with one or more example embodiments. Referring to FIG. 1A, computing environment 100 may include one or more computer systems. For example, computing environment 100 may include a digital twin host platform 102, information source system 103, client device 104, enterprise user device 105, and third party system 106.

As described further below, digital twin host platform 102 may be a computer system that includes one or more computing devices (e.g., servers, server blades, or the like) and/or other computer components (e.g., processors, memories, communication interfaces) that may be used to train, host, and/or otherwise refine a digital twin model, which may, e.g., include a knowledge graph linking together a plurality of individual feature models. In these instances, nodes of the knowledge graph may represent the feature models, and edges between the nodes may represent relationships between the feature models (e.g., how the operation and/or outputs of each model affects the others).

Information source system 103 may include one or more computing devices and/or other computer components (e.g., processors, memories, communication interfaces). In some instances, information source system 103 may include one or more data sources that may store historical information having an effect on vehicle valuations and/or risk (e.g., maintenance cost information, fuel consumption information, insurance cost information, occupancy information, pricing information, vehicle component information, and safety information). Additionally or alternatively, the information source system 103 may include one or more real time sensors (e.g., internet of things sensors and/or other sensors), which may, e.g., provide real time vehicle information. In some instances, these sensors may be located in or around various vehicles and/or vehicle components.

Client device 104 may be a mobile device, tablet, smartphone, desktop computer, laptop computer, and/or other device that may be used by an individual (such as a potential client of a financial institution, who may, e.g., be searching for a loan to purchase or lease a vehicle) to request a loan and/or provide information. In some instances, the client device 104 may be configured to provide one or more user interfaces (e.g., loan interfaces, or the like).

Enterprise user device 105 may be a mobile device, tablet, smartphone, desktop computer, laptop computer, and/or other device that may be used by an individual (such as an underwriter, loan officer, and/or other employee at a financial institution, who may, e.g., be responsible for approving or denying loan requests) to process loan requests. In some instances, the enterprise user device 105 may be configured to provide one or more user interfaces (e.g., loan interfaces, or the like).

Third party system 106 may be or include one or more computing devices and/or other computer components (e.g., processors, memories, communication interfaces). For example, the third party system 106 may be or include one or more servers, server blades, mobile devices, tablets, smartphones, desktop computers, laptop computers, and/or other devices that may be used by a third party for the purpose of leasing or selling vehicles, vehicle components, and/or otherwise. For example, the third party system 106 may be maintained and/or otherwise operated by a vehicle manufacturer, vehicle dealer, vehicle component manufacturer, and/or other organizations. In some instances, the third party system 106 may similarly host one or more digital twin models, and may be configured to communicate with the digital twin host platform 102 to share the outputs of the corresponding digital twin models.

Computing environment 100 also may include one or more networks, which may interconnect digital twin host platform 102, information source system 103, client device 104, enterprise user device 105, third party system 106, or the like. For example, computing environment 100 may include a network 101 (which may interconnect, e.g., digital twin host platform 102, information source system 103, client device 104, enterprise user device 105, third party system 106, or the like).

In one or more arrangements, digital twin host platform 102, information source system 103, client device 104, enterprise user device 105, and/or third party system 106 may be any type of computing device capable of sending and/or receiving requests and processing the requests accordingly. For example, digital twin host platform 102, information source system 103, client device 104, enterprise user device 105, third party system 106, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of digital twin host platform 102, information source system 103, client device 104, enterprise user device 105, and/or third party system 106 may, in some instances, be special-purpose computing devices configured to perform specific functions.

Referring to FIG. 1B, digital twin host platform 102 may include one or more processors 111, memory 112, and communication interface 113. A data bus may interconnect processor 111, memory 112, and communication interface 113. Communication interface 113 may be a network interface configured to support communication between digital twin host platform 102 and one or more networks (e.g., network 101, or the like). Memory 112 may include one or more program modules having instructions that when executed by processor 111 cause digital twin host platform 102 to perform one or more functions described herein and/or one or more databases that may store and/or otherwise maintain information which may be used by such program modules and/or processor 111. In some instances, the one or more program modules and/or databases may be stored by and/or maintained in different memory units of digital twin host platform 102 and/or by different computing devices that may form and/or otherwise make up digital twin host platform 102. For example, memory 112 may have, host, store, and/or include digital twin module 112a and a digital twin database 112b.

Digital twin module 112a may have instructions that direct and/or cause data digital twin host platform 102 to execute advanced techniques to generate digital twin simulations of vehicles and/or vehicle components, and to run the simulations so as to identify costs, risks, and/or other information about the vehicles. In some instances, the digital twin module 112a may include a knowledge graph supported by (and storing relationships between) one or more feature models (which may, in some instances, be machine learning and/or other models). Digital twin database 112b may store information used by digital twin module 112a and/or digital twin host platform 102 in application of advanced techniques to generate and/or otherwise simulate the digital twins of vehicles and/or vehicle components as described above, and/or in performing other functions.

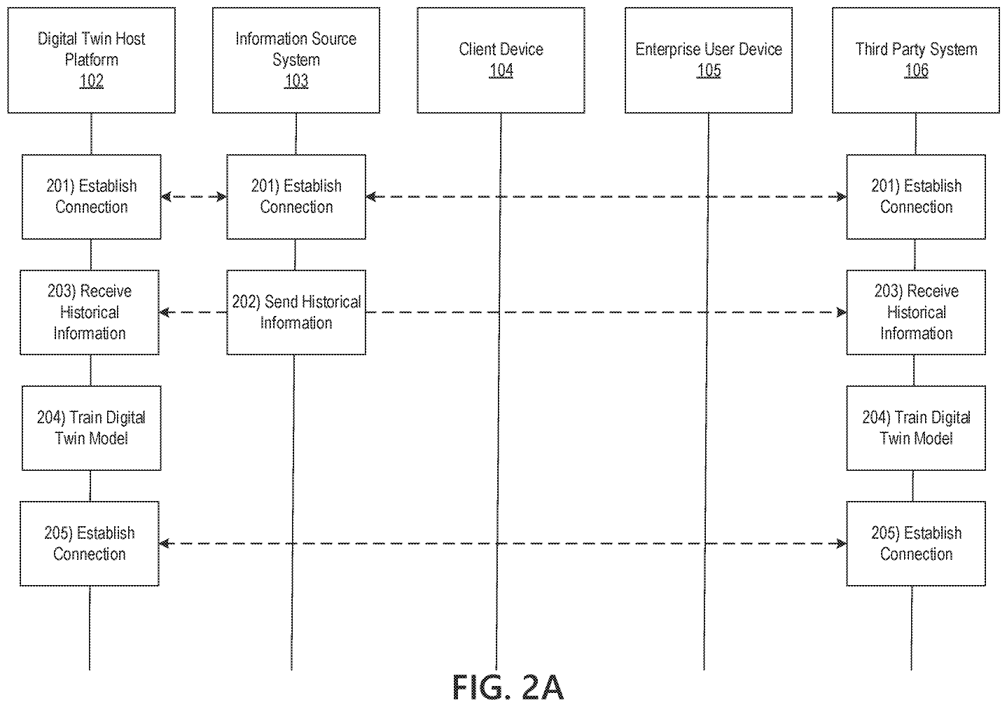

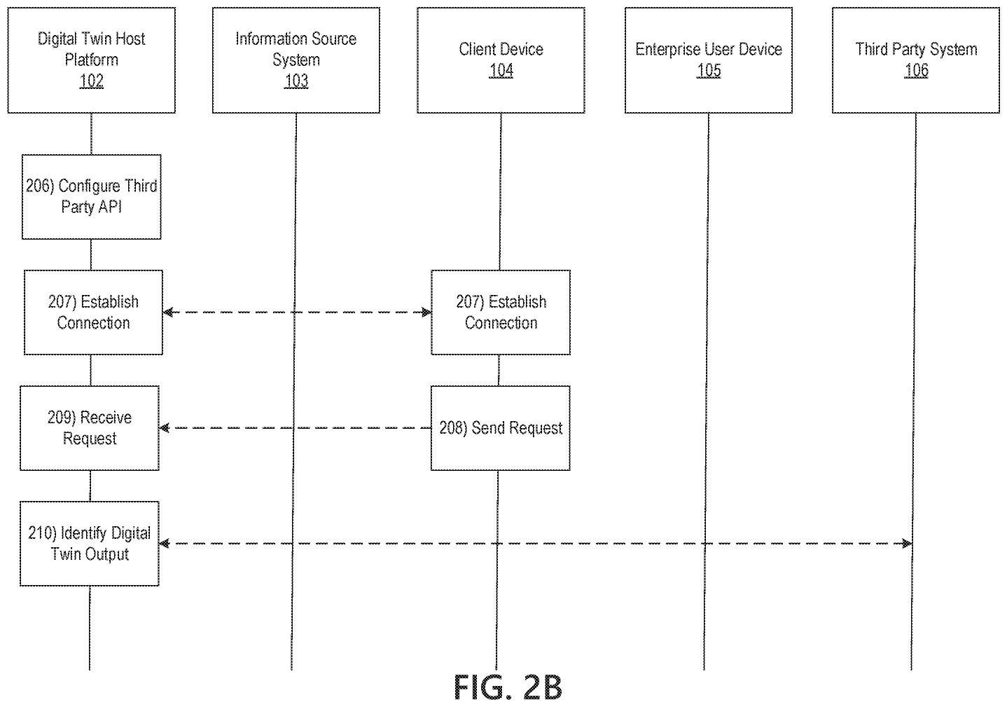

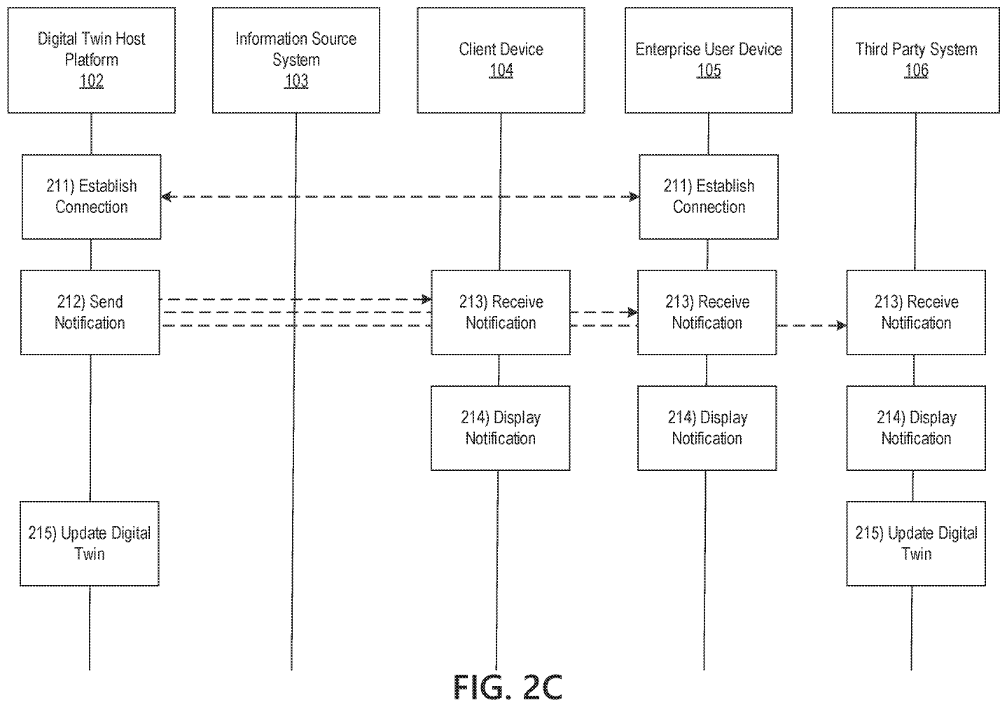

FIGS. 2A-2C depict an illustrative event sequence for digital twin-based vehicle evaluation in accordance with one or more example embodiments. Referring to FIG. 2A, at step 201, information source system 103 may establish a connection with the digital twin host platform 102. For example, the information source system 103 may establish a first wireless data connection with the digital twin host platform 102 to link the information source system 103 to the digital twin host platform 102 (e.g., in preparation for sending historical information). In some instances, the information source system 103 may identify whether or not a connection is already established with the digital twin host platform 102. If a connection is already established with the digital twin host platform 102, the information source system 103 might not re-establish the connection. If a connection is not already established with the digital twin host platform 102, the information source system 103 may establish the first wireless data connection as described herein. In some instances, a similar connection may also be established between the information source system 103 and the third party system 106.

At step 202, the information source system 103 may send historical information to the digital twin host platform 102. For example, the information source system 103 may send the historical information to the digital twin host platform 102 while the first wireless data connection is established. For example, the information source system 103 may send maintenance cost information, maintenance schedule information (e.g., inspection dates, service dates, and/or other information), fuel consumption information, insurance cost information, occupancy information, pricing information (e.g., initial price, price forecasting information, vehicle prices, lease pricing information, and/or other information), vehicle component information (e.g., component types, component lifespan, years since installation, engine information, tire information, air conditioning information, transmission information, and/or other information), historical repair information (e.g., date of last repair, types of repairs, and/or other information), location information (e.g., zip code, location specific average values, and/or other information), deterioration information (e.g., effects of daily use, effects of weather, and/or other information), market information (e.g., stock information, interest rate information, vehicle market trends, and/or other information), school district information, and/or other information that may be used to identify vehicle/lease costs (and/or changes to these values/costs). In some instances, the information source system 103 may similarly send the historical information to the third party system 106.

At step 203, the digital twin host platform 102 may receive the historical information sent at step 202. For example, the digital twin host platform 102 may receive the historical information via the communication interface 113 and while the first wireless data connection is established. In some instances, the third party system 106 may similarly receive the historical information.

Although steps 202 and 203 are described with regard to historical information, the information source system 103 may, in some instances, additionally or alternatively send real time information (similar to the historical information) at any point throughout the illustrative event sequence without departing from the scope of the disclosure. For example, real time information may be sent from one or more data sources, which may, e.g., include internet of things sensors, vehicle sensors, and/or other sensors/data sources.

At step 204, the digital twin host platform 102 may train or otherwise configure a digital twin generation engine to generate a digital twin (e.g., a computer simulation) of vehicle. For example, an enterprise organization such as a financial institution may support customer purchases and/or leases of vehicles by granting a loan, which the customer may pay back to the financial institution over the life of the loan (which may, e.g., span over any period of time). Over the life of the loan and/or lease, a value of the vehicle may change (e.g., due to deterioration, everyday use, market trends, and/or other information). Accordingly, in determining whether or not to issue a loan, and/or an associated interest rate, it may be important for the financial institution to consider a risk of loss not only at the current time, but over the life of the loan. Furthermore, because financial institutions may make such decisions for a large number of vehicles, it may be advantageous to avoid the need to personally evaluate each vehicle, and to instead simulate or otherwise model the vehicles. Thus, it may be advantageous to train a model configured to execute a digital simulation of the vehicle for a period of time corresponding to a lease and/or loan, and to output information based on the simulation.

In some instances, in configuring the digital twin generation engine, the digital twin host platform 102 may configure a plug and play model, which may allow the input of various parameters to create a simulated version of various properties based on characteristics and/or other information of the vehicle (which may, e.g., be included with an event processing request or otherwise). In doing so, the digital twin host platform 102 might not create a unique digital twin generation engine for each vehicle, but rather may be able to simulate any vehicle based on various received inputs (e.g., make, model, year, vehicle type, color, component information, and/or other information). This may achieve certain technical advantages such as conserving memory (e.g., when compared to a database storing digital twins for each vehicle individually).

In some instances, in training the digital twin generation engine, the digital twin host platform 102 may further configure the digital twin generation engine to output a risk score, loan options, similar vehicles for lease or purchase, recommendations, and/or other information based on simulation of a given digital twin, once generated. For example, the digital twin host platform 102 may configure the digital twin generation engine to simulate a vehicle over time (e.g., term of a lease and/or loan), and may output the risk score, loan options, similar vehicles for lease or purchase, recommendations, and/or other information based on results of the simulation.

To do so, the digital twin host platform 102 may generate a knowledge graph that includes the various features for consideration in determining value of a vehicle over time. In some instances, these features may correspond to the various types of historical information described above. In these instances, the digital twin host platform 102 may train models (e.g., machine learning models and/or other models) that may be used to output information corresponding to a particular feature over a particular time period. For example, the digital twin host platform 102 may train, using the historical information, an engine model to analyze engine performance, engine errors, engine deterioration, and/or other engine related parameters. Additionally or alternatively, the digital twin host platform 102 may train, using the historical information, a vehicle make model to analyze market trends, reputation information, lifespan information, driving habits information and/or other vehicle make related parameters. Additionally or alternatively, the computing platform may train, using the historical information, a weather model, configured to analyze weather patterns, precipitation information, wind speeds, sun exposure, and/or other weather information. As another example, the digital twin host platform 102 may train, using the historical information, a pricing model, configured to analyze average vehicle values, market trends, vehicle make/model information, and/or other information. Additionally or alternatively, the digital twin host platform 102 may train, using the historical information, a deterioration model, configured to analyze effects of daily use, repair dates, lifespan of vehicles/components, and/or other information. Additionally or alternatively, the digital twin host platform 102 may train, using the historical information, a predicted costs model, configured to analyze historic trends, lease rates, income ratios, maintenance costs, variable rates, insurance costs, fuel costs, maintenance costs, repair costs, and/or other information. Additionally or alternatively, the digital twin host platform 102 may train, using the historical information, an interest rate model, configured to analyze market trends, historical rates, consumer information, and/or other information to produce a recommended interest rate. Additionally or alternatively, the digital twin host platform 102 may train other models configured to provide outputs that may inform loan decisions (e.g., a fuel consumption model, a vehicle maintenance model, an occupancy model, a vehicle safety model, specific vehicle component models (e.g., engine model, tire model, air conditioning model, transmission model, and/or other component models), a credit history model, stock market model, and/or other models). In these instances, the digital twin host platform 102 may represent such trained models as nodes of the knowledge graph. In some instances, these feature models may be trained using one or more supervised and/or unsupervised learning techniques.

By training each model separately, the digital twin host platform 102 may consider information corresponding to each model in producing outputs (e.g., rather than limiting the amount of information considered using feature engineering, as is described further below). Furthermore, each model may have a different time scale, and thus the features corresponding to each model may have their own unique time scales accordingly.

Similarly, the digital twin host platform 102 may use edges of the knowledge graph (e.g., connecting the nodes) to represent relationships between the various models. For example, the edge between the weather model and the pricing model may indicate that higher average precipitation amounts cause quicker vehicle depreciation (e.g., due to quicker deterioration of the vehicle). As another example, the edge between the deterioration model and the pricing model may indicate that higher deterioration causes lower vehicle values over time. Similarly, the edge between the deterioration model and the predicted costs model may indicate that higher deterioration likelihood causes higher vehicle deterioration may indicate more rapid depreciation in the vehicle value. The knowledge graph may include a number of such edges between all of the models (not merely limited to the illustrative examples described above), which may indicate the interplay between the results of each model.

In some instances, these rules and/or relationships of the knowledge graph edges may be manually defined. Additionally or alternatively, the digital twin host platform 102 may automatically learn these relationships by analyzing the results of the various models for various vehicles, so as to identify the most powerful correlating factors over time. For example, the digital twin host platform 102 may automatically set a rule if a predetermined number of digital twin simulations results in the given correlation (e.g., precipitation values that exceed a given threshold result in more rapid depreciation when compared to similarly situated vehicles with precipitation values that do not exceed the given threshold).

In some instances, one of the feature models within the knowledge graph may be a risk model, configured to output a risk score indicating a level of risk associated with a loan on the particular vehicle or lease thereof. In these instances, there may be a relationship between the level of risk of the vehicle and one or more other features, as represented by an edge between the node of the risk model and the nodes of the remaining models. For example, as price of a vehicle decreases over time, the corresponding risk score may increase, and vice versa.

Accordingly, the digital twin host platform 102 may train the digital twin generation engine to output a risk score for a given vehicle or lease thereof based on its simulation (e.g., if price drops a first predetermined amount over the term of a lease, a first risk score may be output, if price drops a second predetermined amount, greater than the first predetermined amount, over the term of the lease, a second risk score, higher than the first risk score, may be output, etc.). As another example, if average fuel and/or maintenance costs exceed a first predetermined amount, a first risk score may be output, whereas if these costs exceed a second predetermined amount (higher than the first predetermined amount), a second risk score, higher than the first risk score may be output, etc. Similarly, the digital twin host platform 102 may train the digital twin generation engine to output interest rates and/or other loan information based on the identified risk score. For example, the digital twin host platform 102 may train the digital twin generation engine to output a first interest rate if the risk score is greater than or equal to a first risk threshold, a second interest rate if the risk score is greater than or equal to a second risk threshold (less than the first risk threshold), but less than the first risk threshold, and so on.

In some instances, the actions described above with regard to the digital twin host platform 102 and/or the interactions between digital twin host platform 102 and information source system 103 may be performed by or between the information source system 103 and the third party system 106. For example, in some instances, the third party system 106 may train digital twin models based on internal information (e.g., such as information about particular vehicles and/or vehicle components produced or sold by an enterprise corresponding to the third party system 106, such as a vehicle manufacturer, vehicle dealer, component manufacturer, component dealer, or other enterprise). In doing, for example, vehicle manufacturers may train digital twin models for the various vehicles that they produce, which may, e.g., subsequently be accessed and/or otherwise leveraged by the digital twin host platform 102. Similarly, vehicle component manufacturers may train digital twin models for various parts/components that they produce, which may, e.g., subsequently be accessed and/or otherwise leveraged by the digital twin host platform 102 and/or other third party systems. Although a single third party system 106 is illustrated, any number of third party systems 106 may be implemented to perform the methods described herein without departing from the scope of the disclosure.

At step 205, the digital twin host platform 102 may establish a connection with the third party system 106. For example, the digital twin host platform 102 may establish a second wireless data connection with the third party system 106 to link the digital twin host platform 102 to the third party system 106 (e.g., in preparation for configuring an application programming interface (API) hosted or otherwise maintained by the third party system 106). In some instances, the digital twin host platform 102 may identify whether or not a connection is established with the third party system 106. If a connection is already established with the third party system 106, the digital twin host platform 102 might not re-establish the connection. If a connection is not yet established with the third party system 106, digital twin host platform 102 may establish the second wireless data connection as described herein.

Referring to FIG. 2B, at step 206, the digital twin host platform 102 may configure an API with the third party system 106 that may enable the digital twin host platform 102 to access or otherwise leverage the digital twin models of the third party system(s) 106. For example, the digital twin host platform 102 may configure the API so as to enable the digital twin host platform 102 to access digital twin models hosted by manufacturers, dealers, component manufacturers, and/or other enterprises for a particular vehicle for which a lease and/or loan is requested. In doing so, the digital twin host platform 102 may avoid training digital twin models for vehicles/components that are already otherwise available. Furthermore, such third party digital twin models may leverage internal enterprise information for the corresponding third party organization, which may, in some instances, increase accuracy of the models.

At step 207, client device 104 may establish a connection with the digital twin host platform 102. For example, the client device 104 may establish a third wireless data connection with the digital twin host platform 102 (e.g., in preparation for sending an event processing request to the digital twin host platform). In some instances, the client device 104 may identify whether or not a connection is already established with the digital twin host platform 102. If a connection is already established, the client device 104 might not re-establish the connection. If a connection is not yet established, the client device 104 may establish the third wireless data connection as described herein.

At step 208, client device 104 may send an event processing request to the digital twin host platform 102. For example, the client device 104 may send the event processing request to the digital twin host platform 102 while the third wireless data connection is established. In some instances, in sending the event processing request, the client device 104 may send a request to obtain a loan to purchase or lease a vehicle. In some instances, in sending the event processing request the client device 104 may send information of the vehicle. For example, the client device 104 may send a make, model, year, price, and/or other vehicle parameters that may be used to generate a digital twin of the vehicle. Additionally or alternatively, the client device 104 may send information of the corresponding user (e.g., credit information, income information, and/or other information).

At step 209, the digital twin host platform 102 may receive the event processing request sent at step 208. For example, the digital twin host platform 102 may receive the event processing request via the communication interface 113 and while the third wireless data connection is established.

Although the transmission and receipt of the event processing request and other information are described at steps 208 and 209, additional information such as weather information, usage information, repair information, maintenance information, vehicle wear information, and/or other information may also be sent to and received by the digital twin host platform 102 without departing from the scope of the disclosure. In some instances, information may be sent by the third party system 106, client device 104, information source system 103, and/or one or more sensors (e.g., IoT sensors, or the like).

At step 210, the digital twin host platform 102 and/or the third party system 106 may identify a risk score and/or other information for the vehicle, which may, e.g., indicate a level of risk corresponding to providing a loan for the purchase or a lease of the vehicle. For example, the digital twin host platform 102 may identify the features for which information is received (e.g., usage information, weather information, cost information, location information, vehicle make, vehicle model, vehicle year, repair information, maintenance information, vehicle wear information, and/or other information), and may feed information for the given features into their corresponding models within the digital twin generation engine. In doing so, the digital twin host platform 102 may generate a digital twin simulation for the vehicle, which may, e.g., be able to model impact/effects on the vehicle over time. Once generated, the digital twin host platform 102 may execute the digital twin simulation for a period of time, which may, e.g., correspond to a life of a loan and/or lease requested in the event processing request. For instance, if a user is requesting a 3 year loan, the digital twin will be executed for a time period corresponding to 3 years to generate an output that considers costs, changes, and the like over the life of the loan. In executing the digital twin simulation, the digital twin host platform 102 may identify the resulting effects on a value of the vehicle due to deterioration, usage, inclement weather, market trends, and/or other information (e.g., by executing the various feature models and utilizing the relationships between such models embedded in the edges of the knowledge graph).

Once a value has been predicted, the digital twin host platform 102 may compare a difference value, indicating a difference between the current price of the vehicle and a final price of the vehicle (e.g., at the end of the lease/loan term), to one or more predetermined thresholds to identify a risk score. For example, if the price decreased less than 10%, the digital twin host platform 102 may assign a risk score of 3. If the price decreased between 10-30%, the digital twin host platform 102 may assign a risk score of 6. If the price decreased more than 30%, the digital twin host platform may assign a risk score of 9.

Additionally or alternatively, the digital twin host platform 102 may compare average, annual, or over another time period (e.g., the proposed lease term, loan term, and/or other term), maintenance, repair, fuel, and/or other vehicle costs. For example, if the sum of such costs does not exceed a first threshold, the digital twin host platform 102 may assign a risk score of 3. If the costs exceed a first threshold but not a second threshold, the digital twin host platform 102 may assign a risk score of 6. If the price exceeds the second threshold, the digital twin host platform 102 may assign a risk score of 9. In some instances, the digital twin host platform 102 may take an average (or weighted average) of the risk scores related to price and/or costs. In some instances, to execute the digital twin simulation and/or identify prices, costs, risks, and/or other information, the digital twin host platform 102 may leverage the API configured with the third party system(s) 106, so as to access one or more digital twin models hosted by the third party systems(s) 106. In doing so, the digital twin host platform 102 may leverage the models trained by manufacturers, sellers, and/or other enterprises, and may avoid training digital twin models for vehicles/components that are already otherwise available. Furthermore, such third party digital twin models may leverage internal enterprise information for the corresponding third party organization, which may, in some instances, be more accurate than models trained, maintained, and/or otherwise hosted by the digital twin host platform 102 alone.

Once a risk score has been output, the digital twin host platform 102 may identify an interest rate for the requested loan based on the risk score (e.g., by comparing the risk score to one or more predetermined risk thresholds). For example, if the risk score is less than 1, the digital twin host platform 102 may assign a best or lowest available interest rate (e.g., an interest rate of 2.8%). If the risk score is less than 5, but greater than 1, the digital twin host platform 102 may assign next best or next lowest interest rate (e.g., an interest rate of 3.5%). If the risk score is greater than 5, the digital twin host platform 102 may assign a next best or next lowest interest rate (e.g., an interest rate of 5%).

Additionally or alternatively, the digital twin host platform 102 may identify, using the various feature models, one or more similarly situated vehicles (e.g., has a matching vehicle type, color, year, within a common price range (e.g., $15,000-$20,000 range, or the like), and/or is located within the same zip code). In these instances, the digital twin host platform 102 may repeat the above described simulation analysis to output potential risk scores/interest rates for these identified vehicles. For example, the digital twin host platform 102 may identify a similarly situated vehicle with less risk due to less anticipated deterioration. In these instances, the digital twin host platform 102 may identify various vehicle options for a consumer, which may, e.g., have lower interest rates.

By performing this analysis, the digital twin host platform 102 may efficiently and accurately generate loan decisions. In addition to reducing time spent to output loan information (e.g., an automated process may be quicker than manual analysis), the results may be more accurate (e.g., the digital twin generation engine may be capable of considering more features, variables, and/or other information than a human actor). Additionally, using the digital twin generation engine may provide additional technical advantages over other automated techniques such as pure machine learning. For example, in machine learning, due to limitations of processors, models, and/or other computing resources, the number of features considered in a machine learning model may be limited through feature engineering (e.g., so as to select features with the greatest impact on the model output, while causing at least one other feature not to be analyzed by the machine learning model). For example, feature engineering may be used to provide a model output by a single machine learning model, and may cause at least one of the plurality of features to not be analyzed by the single machine learning model In some instances, however, although the remaining features may have less impact on the machine learning output than the selected features, consideration of such remaining features may nevertheless increase accuracy of the final output. Accordingly, by training different models for each feature individually (e.g., rather than a single model trained to consider all features), all such features may be considered in the digital twin analysis. Furthermore, rather than merely outputting individual results from each model, by connecting the feature models through edges of a knowledge graph, the relationships between the outputs of each feature model may also be taken into account in the analysis. As a result, a vehicle may be simulated over time while taking into account all features that may have an impact on risk of loss, interest rates, and/or other information for the vehicles, as well as the relationships between such features, thus increasing accuracy over traditional machine learning methods as well as balancing the limits of memory, processors, and/or other computing resources.

Referring to FIG. 2C, at step 211, the digital twin host platform 102 may establish a connection with the enterprise user device 105. For example, the digital twin host platform 102 may establish a fourth wireless data connection with the enterprise user device 105 to link the digital twin host platform 102 with the enterprise user device 105 (e.g., for purposes of sending notifications and/or responses to the event processing request). In some instances, the digital twin host platform 102 may identify whether a connection is already established with the enterprise user device 105. If a connection is already established with the enterprise user device 105, the digital twin host platform 102 might not re-establish the connection. If a connection is not yet established with the enterprise user device 105, the digital twin host platform 102 may establish the fourth wireless data connection as described herein.

At step 212, the digital twin host platform 102 may send a notification to the client device 104, the enterprise user device 105, and/or the third party system 106 that includes the output of the digital twin analysis (e.g., event processing information). For example, the digital twin host platform 102 may send a notification that includes the rates and/or other vehicles for lease or purchase identified to the client device 104 and/or enterprise user device 105 (which may e.g., allow a customer and/or a loan officer/underwriter to view the information). In some instances, the digital twin host platform 102 may also send information explaining the rates. For example, the digital twin host platform 102 may indicate a feature of the vehicle that primarily contributed to a determination of high risk (such as high maintenance costs, high fuel costs, likelihood of costly repairs, availability of vehicle components, likelihood of deterioration, market trends, or the like). In some instances, the digital twin host platform 102 may send the notification to the client device 104, the enterprise user device 105, and/or the third party system 106 via the communication interface 113 and while the third, fourth, and/or other wireless data connections are established. In some instances, the digital twin host platform 102 may also send one or more commands directing the client device 104, the enterprise user device 105, and/or third party system 106 to display the notification.

At step 213, the client device 104, the enterprise user device 105, and/or the third party system 106 may receive the notifications sent at step 212. For example, the client device 104, the enterprise user device 105, and/or the third party system 106 may receive the notifications while the second, third and/or fourth wireless data connections are established. In some instances, the client device 104, the enterprise user device 105, and/or the third party system 106 may also receive the one or more commands directing the client device 104, the enterprise user device 105, and/or the third party system 106 to display the notifications.

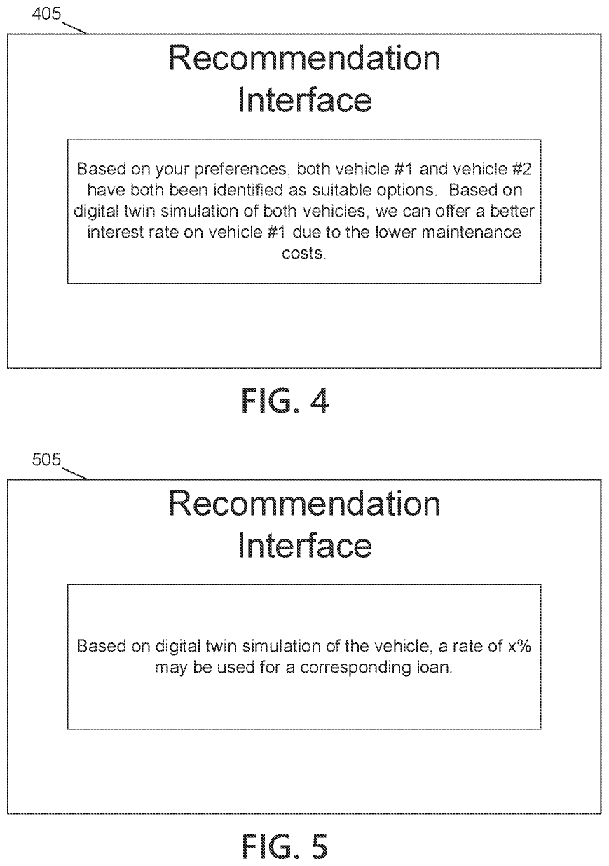

At step 214, based on or in response to the one or more commands directing the client device 104, enterprise user device 105, and/or third party system 106 to display the notification, the client device 104, enterprise user device 105, and/or third party system 106 may display the notification received at step 213. For example, the client device 104 may display a graphical user interface similar to graphical user interface 405, which is illustrated in FIG. 4 and/or graphical user interface 505, which is illustrated in FIG. 5. For example, the client device 104 may display information identifying similarly situated vehicles, interest rates, explanation of rates, and/or other information, such as shown in interface 405. Additionally or alternatively, the enterprise user device 105 may display a graphical user interface similar to graphical user interface 505, which may provide information that may be reviewed or otherwise used by a loan officer, underwriter, and/or other employee in the presenting/denial of a loan request (which may, e.g., include a value of a vehicle, cost of a lease, an amount of confidence indicating risk of loss, anticipated maintenance/repair/fuel/other costs, and/or other information). Additionally or alternatively, the third party system 106 may display similar information as that described above with regard to FIGS. 4 and 5, which may, e.g., allow an enterprise organization corresponding to the third party system 106 to make recommendations accordingly. For example, based on the corresponding risks and/or rates assigned to a given consumer and/or vehicle, a vehicle dealer or salesman may make recommendations to the consumer accordingly (which may, e.g., increase a likelihood of securing a lease or sale due to the increased likelihood of financing, or otherwise).

At step 215, the digital twin host platform 102 and/or the third party system 106 may update the digital twin generation engine based on the outputs generated at step 210 and/or any feedback received from the client device 104 and/or enterprise user device 105 (e.g., received based on the notifications displayed at step 212). In doing so, the digital twin host platform 102 and/or third party system 106 may dynamically and continuously update and/or otherwise refine the digital twin generation engine so as to increase accuracy of the feature models, knowledge graph, simulations, and/or other aspects of the digital twin generation engine.

As described through, a vehicle may refer to any type of personal or commercial vehicle, such as a car, van, SUV, boat, recreational vehicle, motorcycle, bike, and/or other vehicles. Furthermore, although the above described method is primarily described in the context of a vehicle purchase or loan, the method may be applied to any other types of vehicle transactions without departing from the scope of the disclosure. Furthermore, the methods could be applied to any other durable goods, appliances, and/or other goods without departing from the scope of the disclosure.

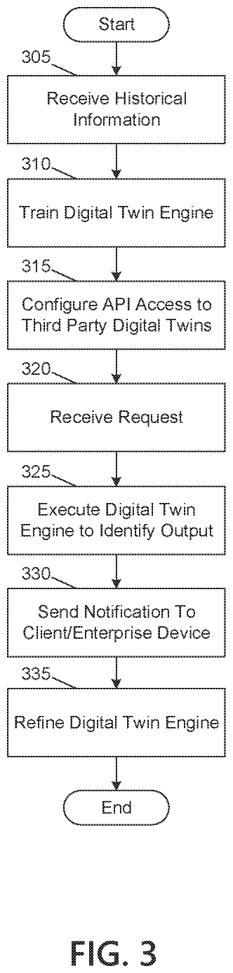

FIG. 3 depicts an illustrative method for digital twin-based vehicle evaluation in accordance with one or more example embodiments. Referring to FIG. 3, at step 305, a computing platform having at least one processor, a communication interface, and memory may receive historical information. At step 310, the computing platform may train a digital twin generation engine, which may include training one or more feature models and/or generating a knowledge graph. At step 315, the computing platform may configure API access to one or more third party digital twins. At step 320, the computing platform may receive an event processing request. At step 325, the computing platform may execute the digital twin engine to identify a model output. At step 330, the computing platform may send a notification to a client device and/or enterprise user device based on the model output. At step 335, the computing platform may refine the digital twin engine based on the model output and/or user feedback information.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
receive historical vehicle information;
train, using the historical vehicle information, a digital twin vehicle evaluation engine, configured to model a vehicle based on characteristics of the vehicle using a computer simulation, wherein:
training the digital twin vehicle evaluation engine further configures the digital twin vehicle evaluation engine to output event processing information for the vehicle, and
training the digital twin vehicle evaluation engine comprises generating a knowledge graph, wherein each node of the knowledge graph comprises a machine learning model and each edge of the knowledge graph represents relationships between features corresponding to each machine learning model;
receive, from a client device, an event processing request identifying a first vehicle;
generate, using the digital twin vehicle evaluation engine, a computer simulation of a lease term corresponding to the first vehicle;
execute, for a period of time corresponding to the lease term, the computer simulation of the first vehicle to output event processing information for the first vehicle; and
send, to the client device, the event processing information and one or more commands directing the client device to display the event processing information, wherein sending the one or more commands directing the client device to display the event processing information causes the client device to display the event processing information.

2. The computing platform of claim 1, wherein the historical vehicle information includes, for a plurality of vehicles including the first vehicle, one or more of: maintenance cost information, fuel consumption information, insurance cost information, occupancy information, pricing information, vehicle component information, and safety information.

3. The computing platform of claim 1, wherein the machine learning models comprise one or more of: a vehicle market trend model, a weather model, a vehicle maintenance model, a fuel consumption model, an occupancy model, a vehicle safety model, specific vehicle component models, or a stock market model.

4. The computing platform of claim 1, wherein the machine learning models are characterized by different time scales.

5. The computing platform of claim 1, wherein the machine learning models output information for each of a plurality of features, wherein feature engineering is used to provide a model output by a single machine learning model, and wherein the feature engineering causes at least one of the plurality of features to not be analyzed by the single machine learning model.

6. The computing platform of claim 1, wherein the relationships between the features indicate how each feature affects other features.

7. The computing platform of claim 6, wherein the digital twin vehicle evaluation engine automatically learns the relationships over time.

8. The computing platform of claim 6, wherein the relationships are manually defined.

9. The computing platform of claim 1, wherein the event processing information indicates one or more of: loan information or a risk score indicating a level of risk associated with providing a loan for one of: a purchase or a lease of the first vehicle.

10. The computing platform of claim 9, wherein the event processing information includes an explanation of the loan information or the risk score.

11. The computing platform of claim 1, wherein the event processing information indicates a second vehicle, with a predetermined number of matching features to the first vehicle, along with loan information for both the first vehicle and the second vehicle, wherein the second vehicle has a lower risk score than the first vehicle, and a lower interest rate than the first vehicle.

12. The computing platform of claim 1, wherein the memory stores additional computer-readable instructions that, when executed by the one or more processors, further cause the computing platform to:
configure an application programming interface (API) to access one or more additional digital twin vehicle evaluation engines, each hosted by a third party system corresponding to one of: a vehicle manufacturer, a vehicle dealer, or a vehicle component manufacturer, wherein configuring the API enables the computing platform to access outputs from the one or more additional digital twin vehicle evaluation engines, and wherein outputting the event processing information for the first vehicle is further based on the outputs.

13. The computing platform of claim 12, wherein the one or more additional digital twin vehicle evaluation engines are trained using additional information, not included in the historical vehicle information.

14. The computing platform of claim 1, wherein the first vehicle comprises one of: a personal vehicle, a recreational vehicle, a motorcycle, or a boat.

15. A method comprising:
at a computing platform comprising at least one processor, a communication interface, and memory:
receive historical vehicle information;
train, using the historical vehicle information, a digital twin vehicle evaluation engine, configured to model a vehicle based on characteristics of the vehicle using a computer simulation, wherein:
training the digital twin vehicle evaluation engine further configures the digital twin vehicle evaluation engine to output event processing information for the vehicle, and
training the digital twin vehicle evaluation engine comprises generating a knowledge graph, wherein each node of the knowledge graph comprises a machine learning model and each edge of the knowledge graph represents relationships between features corresponding to each machine learning model;
receive, from a client device, an event processing request identifying a first vehicle;
generate, using the digital twin vehicle evaluation engine, a computer simulation of a lease term corresponding to the first vehicle;
execute, for a period of time corresponding to the lease term, the computer simulation of the first vehicle to output event processing information for the first vehicle; and
send, to the client device, the event processing information and one or more commands directing the client device to display the event processing information, wherein sending the one or more commands directing the client device to display the event processing information causes the client device to display the event processing information.

16. The method of claim 15, wherein the historical vehicle information includes, for a plurality of vehicles including the first vehicle, one or more of: maintenance cost information, fuel consumption information, insurance cost information, occupancy information, pricing information, vehicle component information, and safety information.

17. The method of claim 15, wherein the machine learning models comprise one or more of: a vehicle market trend model, a weather model, a vehicle maintenance model, a fuel consumption model, an occupancy model, a vehicle safety model, specific vehicle component models, or a stock market model.

18. The method of claim 15, wherein the machine learning models are characterized by different time scales.

19. The method of claim 15, wherein the machine learning models output information for each of a plurality of features, wherein feature engineering is used to provide a model output by a single machine learning model, and wherein the feature engineering causes at least one of the plurality of features to not be analyzed by the single machine learning model.

20. One or more non-transitory computer-readable media storing instructions that, when executed by a computing platform comprising at least one processor, a communication interface, and memory, cause the computing platform to:
receive historical vehicle information;
train, using the historical vehicle information, a digital twin vehicle evaluation engine, configured to model a vehicle based on characteristics of the vehicle using a computer simulation, wherein:
training the digital twin vehicle evaluation engine further configures the digital twin vehicle evaluation engine to output event processing information for the vehicle, and
training the digital twin vehicle evaluation engine comprises generating a knowledge graph, wherein each node of the knowledge graph comprises a machine learning model and each edge of the knowledge graph represents relationships between features corresponding to each machine learning model;
receive, from a client device, an event processing request identifying a first vehicle;
generate, using the digital twin vehicle evaluation engine, a computer simulation of a lease term corresponding to the first vehicle;
execute, for a period of time corresponding to the lease term, the computer simulation of the first vehicle to output event processing information for the first vehicle; and
send, to the client device, the event processing information and one or more commands directing the client device to display the event processing information, wherein sending the one or more commands directing the client device to display the event processing information causes the client device to display the event processing information.
